(19) United States
(12) Patent Application Publication
(10) Pub. No.: US 2007/0189412 A1
(43) Pub. Date: Aug. 16, 2007

(54) Method and system for sounding packet exchange in wireless communication systems

(75) Inventors: Pengfei Xia, Mountain View, CA (US); Huaning Niu, Sunnyvale, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/706,942

(22) Filed: Feb. 13, 2007

Related U.S. Application Data
(60) Provisional application No. 60/773,829, filed on Feb. 15, 2006.

(51) Int. Cl. H04L 25/49

(52) U.S. Cl. 375/292

(57) ABSTRACT

A method and system for sounding packet exchange in wireless communication involves generating a training request (TRQ) specifying a number of long training fields (LTFs), and transmitting a TRQ from an initiator (transmit station) having multiple antennas to a responder (receive station) over a wireless channel, wherein the TRQ specifies the number of LTFs based on the number of initiator antennas. The responder then transmits a sounding packet to the initiator, wherein the sounding packet includes multiple LTFs corresponding to the number of LTFs specified in the TRQ. Based on the sounding packet, the initiator transmits a beamforming transmission to the responder to enable wireless data communication therebetween.

### RELATED APPLICATION

This application claims priority from U.S. Provisional Patent Application Ser. No. 60/773,829, filed on Feb. 15, 2006, incorporated herein by reference.

### FIELD OF THE INVENTION

The present invention relates to wireless communication systems and in particular, to sounding format exchange in wireless communication systems.

### BACKGROUND OF THE INVENTION

In wireless communication systems, antenna array beamforming provides increased signal quality (due to high directional antenna gain) and extended communication range by steering the transmitted signal in a dedicated direction. For this reason, such beamforming has been widely adopted in radar, sonar and other communication systems.

The beamforming operation can be implemented either: (1) in the analog domain, after a digital-to-analog (D/A) converter at a transmit station and before an analog-to-digital (A/D) converter at a receive station, or (2) in the digital domain, before the D/A converter at the transmit station and after the A/D converter at the receive station.

There are two primary approaches for carrying out beamforming in the analog domain. One is switched beamforming and the other is adaptive beamforming. In switched beamforming, a number of beam directions are pre-defined, and a controller always selects the best beam direction out of those pre-defined directions for each and every data packet. This approach is relatively simple and requires low feedback, although choice of the beam coefficients across multiple antenna elements is highly constrained, leading to suboptimal performance. A typical example of this is known as the Butler matrix implementation 100 as shown in FIG. 1 and described in J. Butler and R. Lowe, “Beam-Forming Matrix Simplifies Design of Electronically Scanned Antennas,” Electronic Design, pp. 170-173, Apr. 12, 1961.

In adaptive beamforming, there is no constraint on the coefficients across multiple antenna elements. Thus, with more feedback and computational complexity, an adaptive beamforming approach can provide high array gain and excellent system performance. Adaptive beamforming is also more versatile in suppressing interference and in extending the communication range.

In the IEEE 802.11n specification (“Draft Amendment to Standard for Information Technology-Telecommunications and information exchange between systems-Local and metropolitan area networks-Specific requirements-Part 11: Wireless LAN Medium Access Control (MAC) and Physical Layer (PHY) specifications: Enhancements for Higher Throughput,” IEEE P802.11n/D1.0, March 2006), incorporated herein by reference, an optimal adaptive beamforming approach is proposed wherein the full channel knowledge is required.

For example, when an initiator (transmit station) has a 16-antenna planar array and a responder (receive station) has a 16-antenna planar array, a 16×16 channel matrix needs to be estimated. In order to estimate the 16×16 channel matrix using the sounding packet according to the aforementioned IEEE 802.11n specification, 16 sounding packets need to be transmitted from the responder to the initiator and in each sounding packet, 16 long preambles must be transmitted. Further, because the optimal beamforming approach uses instantaneous channel knowledge, the sounding exchange is required frequently. This causes a dramatic increase in overhead and significantly reduces the system throughput. As such, there is a need for an efficient sounding format and an exchange protocol for beamforming in wireless communication systems.

### BRIEF SUMMARY OF THE INVENTION

The present invention provide a sounding packet exchange method and system for wireless communication by generating a training request (TRQ) specifying a number of long training fields (LTFs), and transmitting a TRQ from an initiator (transmit station) having multiple antennas to a responder (receive station) over a wireless channel, wherein the TRQ specifies the number of LTFs based on the number of initiator antennas.

The responder then transmits a sounding packet to the initiator, wherein the sounding packet includes multiple LTFs corresponding to the number of LTFs specified in the TRQ. Based on the sounding packet, the initiator transmits a beamforming transmission to the responder to enable wireless data communication therebetween. This provides a sounding packet format and an exchange protocol for wireless beamforming using statistical channel information.

An example wireless communication system, according to the present invention, implements a sounding format and an exchange protocol between an initiator and a responder by: (1) transmitting a TRQ from the initiator to the responder, wherein the initiator includes N antennas and the responder includes M antennas, the TRQ specifying a number of LTFs required in a forward sounding packet; and (2) transmitting a forward sounding packet from the responder to the initiator, wherein the forward sounding packet includes multiple LTFs corresponding to said number of LTFs specified in the TRQ. The forward sounding packet is used in the initiator to determine the transmit analog beamforming vector.

The exchange process may further include transmitting a reverse TRQ from the responder to the initiator, the reverse TRQ specifying the number of LTFs required in a reverse sounding packet; and transmitting a reverse sounding packet from the initiator to the responder, wherein the reverse sounding packet includes multiple LTFs corresponding to said number of LTFs specified in the reverse TRQ. The reverse sounding packet is used for estimating the channel, calculating the statistical channel information and forming an adaptive receive beamforming vector. Based on the forward and the reverse sounding packets, simultaneous analog beamforming is performed at the initiator and at the responder.

Such sounding packets and protocols in accordance with the present invention provide an efficient way to perform either switched beamforming or statistical adaptive beamforming. They also provide a general platform/protocol by which adaptive beamforming is carried out simultaneously at the initiator side and at the responder side, with both sides equipped with an antenna array.

These and other embodiments, aspects and advantages of the present invention will become understood with reference to the following description, appended claims and accompanying figures.

### BRIEF DESCRIPTION OF THE DRAWINGS

FIG. 1 shows a switched beamforming method in wireless communications using a Butler matrix.

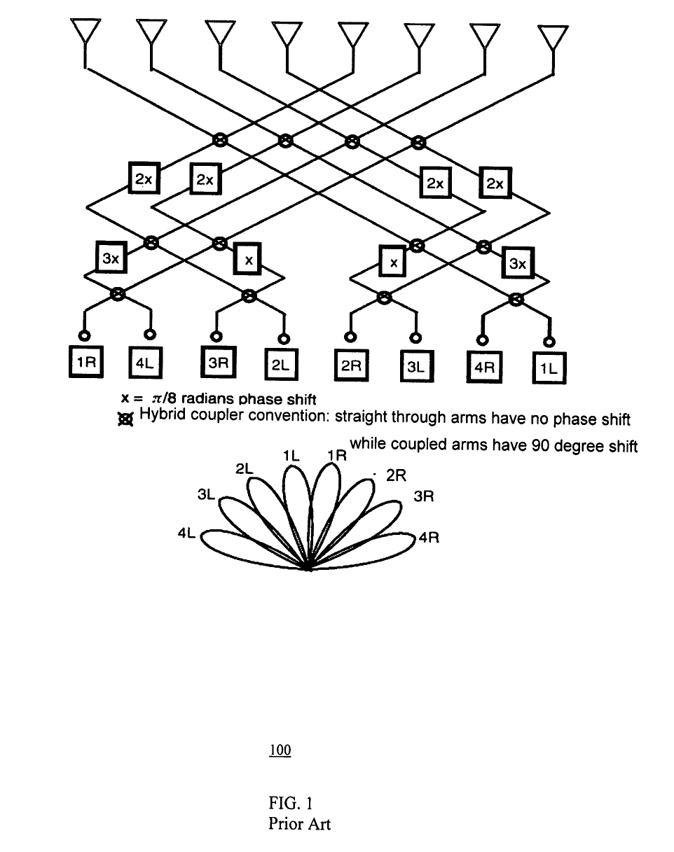

FIG. 2A shows a transmit station block diagram of an example wireless (e.g., radio frequency (RF)) communication system implementing analog beamforming using a sounding format and an exchange protocol, according to an embodiment of the present invention.

FIG. 2B shows a receive station block diagram of an example wireless communication system implementing analog beamforming using a sounding format and an exchange protocol corresponding to the transmit station of FIG. 2A, according to an embodiment of the present invention.

FIG. 3A shows a conventional preamble format according to the aforementioned IEEE 802.11n specification.

FIG. 3B shows a conventional sounding packet preamble format according to the aforementioned IEEE 802.11n specification.

FIG. 3C shows a sounding packet preamble format for a wireless communication system, according to an embodiment of the present invention.

FIG. 4 shows an example functional flow of a sounding protocol for N×1 beamforming in a wireless communication system, according to an embodiment of the present invention.

FIG. 5 shows an example functional flow of a sounding protocol for N*M beamforming in a wireless communication system, according to an embodiment of the present invention.

FIG. 6 shows an example of the protocol architecture for an analog beamforming wireless communication system, according to an embodiment of the present invention.

### DETAILED DESCRIPTION OF THE INVENTION

The present invention provides a sounding format for analog beamforming and sounding exchange protocol for statistical beamforming, in wireless communication systems. In one implementation, this involves analog beamforming based on a sounding format and a sounding exchange protocol, for statistical beamforming between a transmit station (initiator) and a receive station (responder).

A sounding packet format and a training exchange protocol are configured for general beamforming, including switched beam beamforming and different adaptive beamforming processes. Because there is only one RF chain in analog beamforming, a sounding preamble according to the present invention is designed as a modification of the aforementioned IEEE 802.11n sounding preamble.

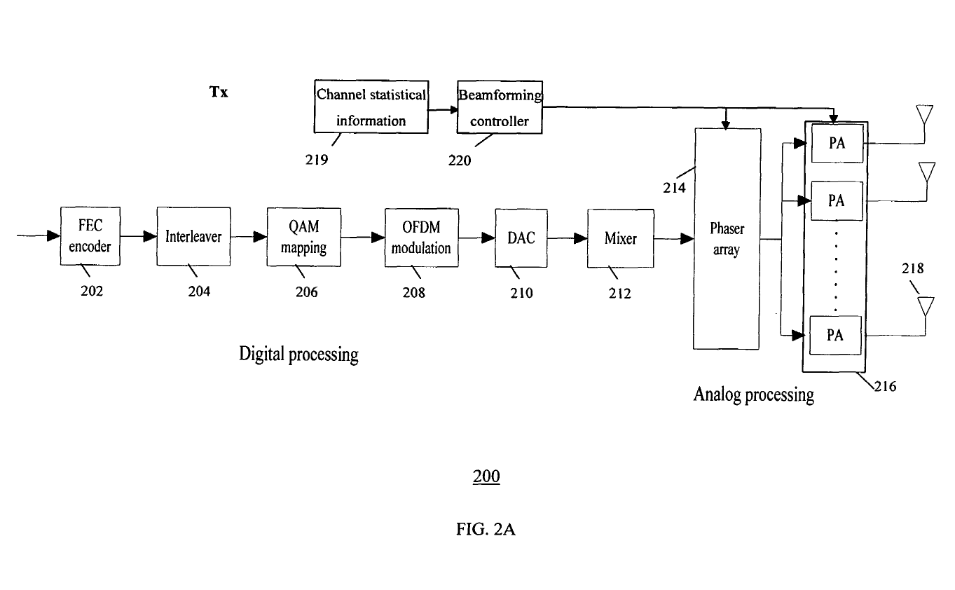

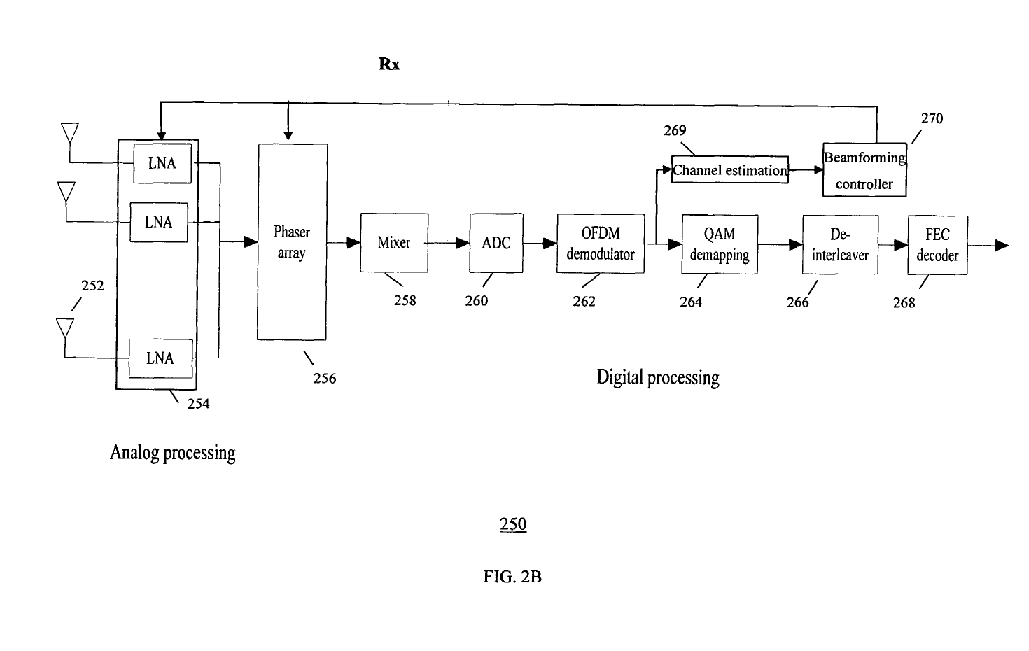

FIGS. 2A-B show block diagrams of a transmit station (Tx) and a receive station (Rx), respectively, which form an example wireless communication system according to the present invention. In this description the transmit station is a type of wireless communication station capable of transmitting and/or receiving over a wireless channel in a wireless communication system such as a wireless local area network (WLAN). Similarly, the receive station is a type of wireless communication station capable of transmitting and/or receiving over a wireless channel in a wireless communication system such as a WLAN. Therefore, a wireless communication station herein can function as a transmitter and/or a receiver, an initiator and/or a responder, etc.

Specifically, FIG. 2A shows a functional block diagram of an example transmit station (Tx) 200 for a RF wireless communication system implementing analog beamforming, according to an embodiment of the present invention. The transmit station 200 includes a digital processing section and an analog processing section. The digital processing section includes, in relevant part, a forward error correction (FEC) encoder 202 that encodes an input bit stream, an interleaver 204 that interleaves the encoded bit using a block interleaver, a Quadrature Amplitude Modulation (QAM) mapper 206 that maps the interleaved bits to symbols using a Gray mapping rule, an orthogonal frequency division multiplexing (OFDM) modulator 208 that performs OFDM modulation on the symbols, and a D/A converter (DAC) 210 generating a baseband signal.

The analog processing section in which analog beamforming takes place, includes: a mixer 212, a phaser array 214, a power amplifier (PA) array 216 and corresponding transmit antennas 218. The mixer 212 modulates the baseband signal into transmission frequency, and the phaser array 214 applies different phase shifts to the signal for each transmit antenna. Then, the PA array 216 applies a different power loading to the signal for each transmit antenna.

FIG. 2B shows an example block diagram of a receive station (Rx) 250 corresponding to the transmit station 200. The receive station 250 includes an analog processing section and a digital processing section. The analog processing section includes multiple receive antennas 252, a LNA array 254, a phaser array 256 and a mixer 258. The LNA array 254 amplifies the analog signals received by the receive antennas 252. The phaser array 256 applies different phase shifts to the signal from each receive antenna. Then, the mixer 258 modulates the output signal from the phaser array 256 to a baseband signal.

The digital processing section of the receive station 250 includes an analog-to-digital (ADC) converter 260, an OFDM demodulator 262, a QAM demapper 264, a deinterleaver 266 and an FEC decoder 268. The digital processing section of the receive station 250 performs reverse steps of the digital processing section in the transmit station.

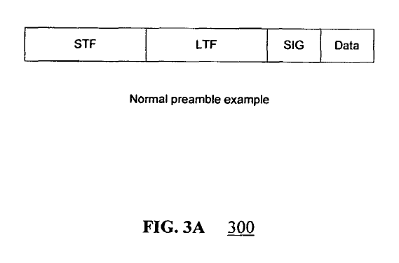

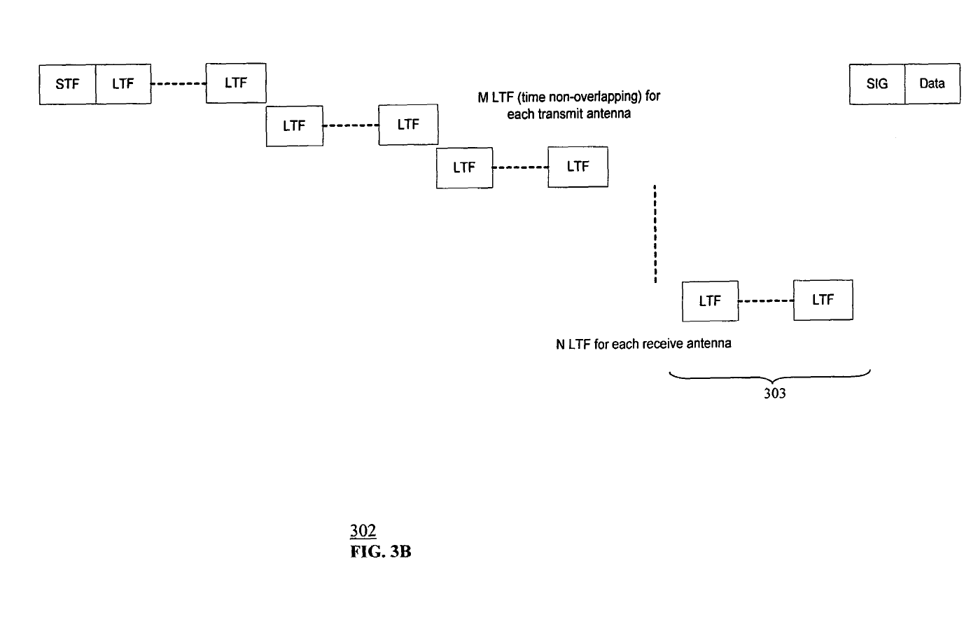

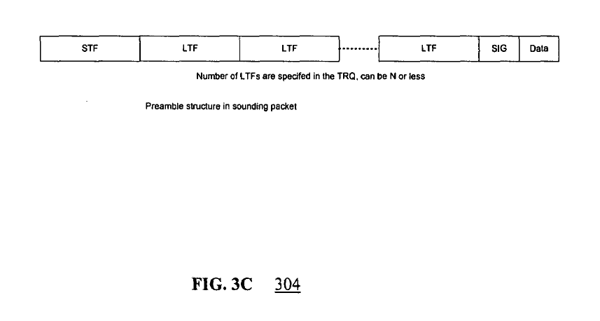

In order to better describe the differences between a sounding packet and an exchange protocol according to the present invention, compared to the conventional approach, first a brief description of the conventional sounding packet preamble format is provided. FIG. 3A shows a conventional IEEE 802.11n preamble format 300 per packet. The preamble 300 includes: a short training field (STF), a LTF, a signal field (SIG), and a data field. This sounding format applies to MIMO system where the number of RF chains equals the number of antennas. FIG. 3B shows an example of applying IEEE 802.11n sounding preamble format 302 per packet to analog beamforming where only one RF chain is available. The sounding preamble 302 includes: a STF, N repeated LTFs for each receive antenna, and M repeated LTFs for each transmit antenna, non-overlapping in time. For a communication system with M transmit antennas and N receive antennas, a sounding packet 303 (including N LTFs) must be sent from the receiver to the transmitter using one receiver antenna at a time. This results in a total of M sounding packets transmitted. The total length of the LTFs is calculated as N×M.

FIG. 3C shows an example sounding preamble format 304, according to the present invention. For the preamble format 304, the number of LTFs is specified in a TRQ, which is related to the number of antennas and the beamforming method used. When only direction of arrival (DoA) or direction of departure (DoD) is used for beamforming, the number of LTFs can be less than the number of transmit antennas. According to the present invention, an additional field (e.g., 1 byte) in the TRQ indicates the desired number of LTFs in the sounding packet. As such, in the sounding preamble 304 according to the present invention, the LTF is repeated according to the number specified in the TRQ, which is less or equal to the number of transmit antennas. This is much shorter compared to that of the conventional preamble 302.

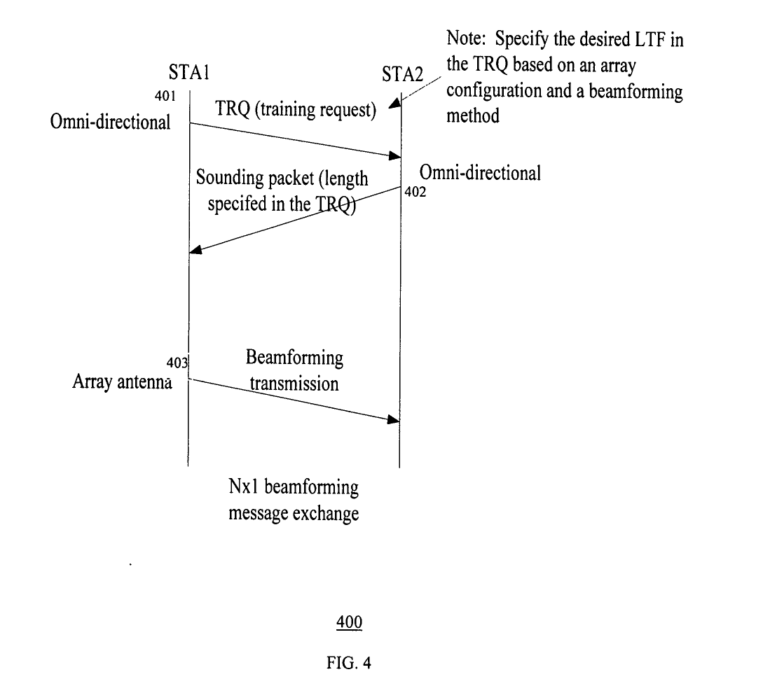

FIG. 4 shows an example event flow diagram 400 of a sounding protocol for N×1 beamforming in a training exchange protocol using the sounding packet preamble format 304, according to the present invention. The flow diagram is a communication scenario wherein the transmit station 200 includes multiple (N) transmit antennas and the receive station 250 uses only one receive antenna in omni-directional mode. In the flow diagram 400 of FIG. 4, the transmit station 200 is identified as a first wireless communication station STA1, and the receive station 250 is identified as a second wireless communication station STA2. Further, the solid arrows indicate transmissions over a wireless channel in the following event sequence (from top to bottom of the drawing in FIG. 4):

Omni-Directional
Step 401: In the omni-directional mode, STA1 sends (transmits) a TRQ to STA2, specifying the desired number of LTFs in the said additional field in the TRQ based on the selected antenna array configuration and beamforming method.
Step 402: In the omni-directional mode, STA2 generates and sends a sounding packet to STA1 using the sounding preamble format 304 (FIG. 3C), wherein the sounding packet includes the desired/requested number of LTFs as specified in said additional field in the TRQ.

Array Antenna
Step 403: Based on the sounding packet received from STA2, STA1 calculates the transmit beamforming vector and then starts high-rate transmission to STA2 via an analog beamforming scheme to STA2 using array antennas with transmit beamforming implemented at the transmit station. In this step, as the protocol is applied for a N×1 system, there is no beamforming at the receiver side.

In one example, analog beamforming in step 403 is accomplished by first using the sounding packet information in a channel statistical information computational module 219 of the transmit station 200 (FIG. 2A), to generate channel statistical information. Then, the channel statistical information is used by a beamforming controller 220 to generate a beamforming vector for controlling the phaser array 214 and the PA array 216, for analog beamforming. The transmit beamforming vector can be determined by e.g. eigen-decomposition of a channel correlation matrix, wherein the transmit station 200 performs analog beamforming based on direction-of-departure information. In the transmit station 200, the modulated analog signals from the mixer 212 are input to the phaser array 214, which in conjunction with the beamforming controller 220, applies a coefficient vector W_{T} to the analog signals for transmitter beamforming. The analog signals, after passing through the power amplifier array 216, are then transmitted to the receive station 250 over transmitter antennas 218. The transmit beamforming coefficient vector W_{T} comprises elements e^{jφ}₁ . . . e^{jφ}_{N}, wherein φ₁ . . . φ_{N} are beamforming phase coefficients that are calculated by the beamforming controller 220 and controlled digitally at baseband. The elements in the coefficient vector W_{T} are complex numbers, wherein the phase coefficient φ₁ . . . φ_{N} are applied by phaser array elements.

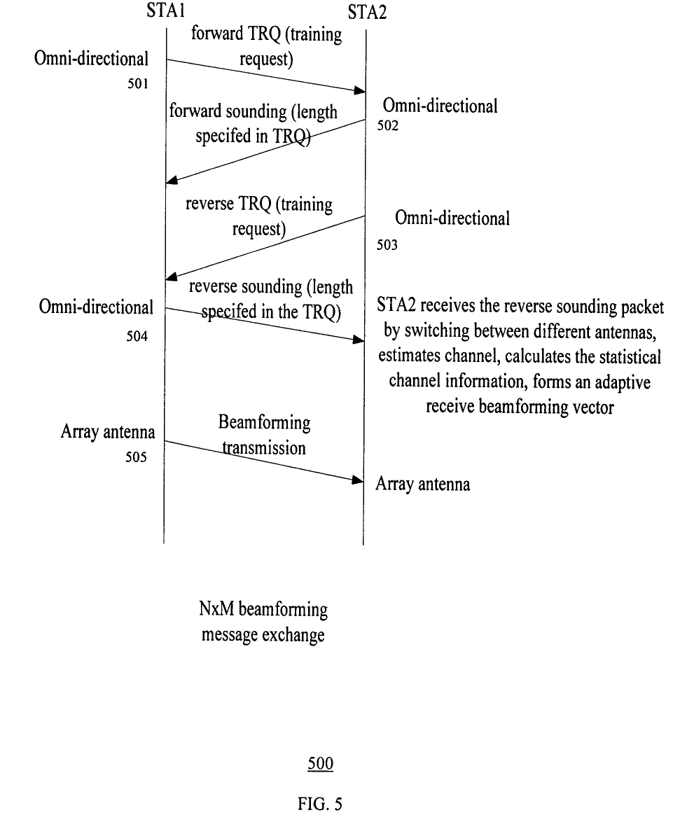

FIG. 5 shows the diagram 500 of sounding protocols for N*M beamforming in a training exchange protocol, according to the present invention. In this example, the transmit station 200 includes multiple (N>1) antennas and the receive station 250 includes multiple (M>1) antennas. Said additional field (1 byte) in the TRQ indicates the desired number of LTFs in the sounding packet. The purpose is to obtain essentially the best transmission performance and efficiency tradeoff based on different beamforming implementations. The number of LTFs length needs to be at least 2 since both N>1 and M>1. This is to obtain essentially the minimum information required for beamforming.

The N×M beamforming message exchange in FIG. 5 is between two stations (STA1: transmit station 200, and STA2: receive station 250), wherein the solid arrows indicate transmissions in the following sequence (from top to bottom of FIG. 5):
Step. 501: First, STA1 omni-directionally transmits a forward TRQ to the receive station (STA2). The forward TRQ specifies the number of LTFs required in a forward sounding packet, based on the number N of transmit antennas.
Step 502: Upon receiving the forward TRQ, STA2 omni-directionally transmits a forward sounding packet using a preamble format 304 (FIG. 3C), wherein the length of the sounding packet (the number of LTFs) has been specified in the forward TRQ. The forward sounding packet is received by STAL by switching between different antennas, and used in calculating the transmit beamforming vector (e.g., either through eigen-decomposition of the channel correlation matrix or through a direction-of-arrival (DoA) estimation). The sounding packet provides the required information for beamforming, wherein the actual analog beamforming method is an implementation choice.
Step 503: STA2 then omni-directionally transmits a reverse TRQ which specifies the number of LTFs required in a reverse sounding packet, based on the number M of antennas.
Step 504: Upon receiving the reverse TRQ, STA1 omni-directionally transmits a reverse sounding packet using a preamble format 304 (FIG. 3C), wherein the length of the sounding packet (the number of LTFs therein) is as specified in the reverse TRQ. STA2 receives the reverse sounding packet by switching between different antennas and forms an adaptive receive beamforming vector from the reverse sounding packet information.
Step 505: A high rate transmission sequence using array antennas then follows, with beamforming implemented at both the transmit station and the receive station.

In step 504, in one example the receiver station 250 uses the reverse sounding packet in an estimator 269 (FIG. 2B) to estimate the channel statistical information. The channel statistical information is used in a beamfoming controller 270 to calculate an adaptive receive beamforming vector for controlling the phaser array 256 and the LNA array 254. The transmitted signals are received by the receive station 250 and amplified by the LNA array 254 using power level coefficients β₁ . . . β_{N} based on control signals from the controller 270. The amplified signals are processed in the phaser array 256 based on control signals from the controller 270, using a receiver beamforming coefficient vector W_{R}. The coefficient vector W_{R}=[β₁e^{jφ}^{₁} . . . β_{N}e^{jφ}^{_{M}}] comprises elements e^{jφ}₁ . . . e^{jφ}_{M}, wherein φ₁ . . . φ_{M} represent receive phase coefficients which are determined by the controller 270.

Accordingly, steps 401-403 and 501-505 implement an example wireless transmission protocol between a transmit station 200 (STA1) and a receive station 250 (STA2), according to the present invention. The transmission protocol includes an initial training protocol using a sounding packet format 304 (FIG. 3C), whereby STAL and STA2 are decoupled. The sounding packet and exchange protocols according to the present invention allow performing either switched beamforming or statistical adaptive beamforming, and provide a general platform/protocol by which adaptive beamforming is carried out simultaneously at the transmit station 200 and at the receive station 250.

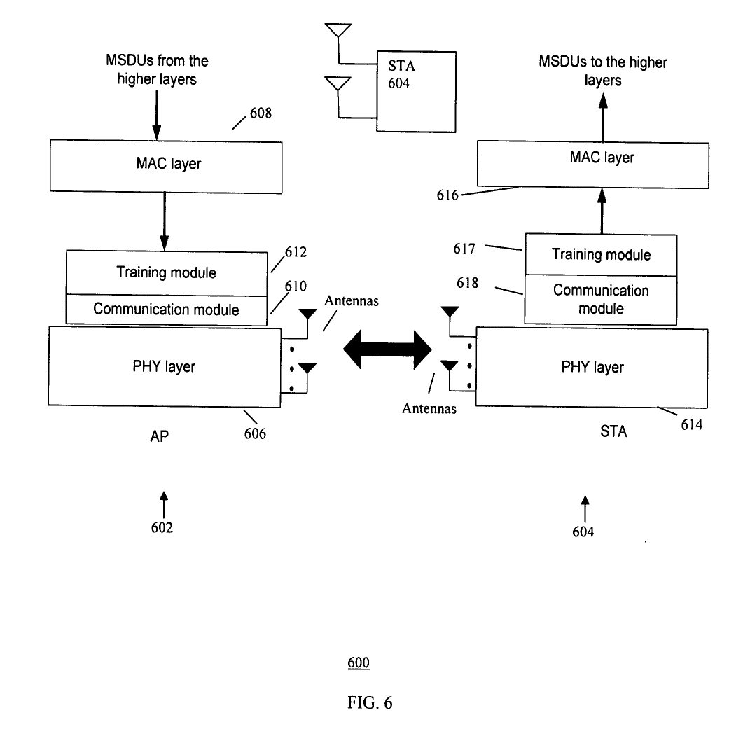

FIG. 6 shows an example of the protocol architecture 600 for an access point (AP) initiator 602 and one or more responders (STAs) 604. The AP 602 comprises a physical (PHY) layer 606 and a media access control (MAC) layer 608. The PHY layer 606 implements a type of IEEE 802.11 communication standard for transmitting data over a channel. The AP 602 further includes a communication module 610 and a training module 612. The modules 610 and 612 are preferably implemented in the PHY layer 606. The training module 612 forms forward TRQs and reverse sounding packets, and the communication module 610 performs analog beamforming for the AP 602, according to the present invention as discussed above.

Each STA 604 includes a PHY layer 614 corresponding to the PHY layer 606 of the AP 602 and a MAC layer 616. The STA 604 further includes a communication module 618 and a training module 617. The modules 617 and 618 are preferably implemented in the PHY layer 614. The training module 617 forms reverse TRQs and forward sounding packets, and the communication module 618 performs analog beamforming for the STA 604, according to the present invention as discussed above. A forward TRQ is a frame that requires the next transmission by the STA 604 to be a sounding PLCP (physical layer convergence protocol) protocol data unit (PPDU) with specified physical layer attributes. The TRQ frame includes one or more of an ACK policy field, a request identity number field, a response time policy field and an aggregation format field in addition to a channel sounding parameters field. Similarly, a reverse TRQ is a frame that requires the next transmission by the AP 602 to be a sounding PPDU with specified physical layer attributes.

As such, the present invention provides a sounding packet format and an exchange protocol for wireless analog beamforming using statistical channel information are provided for general N×M systems. An initiator transmits a TRQ to a responder over a wireless channel, wherein the TRQ specifies a number of LTFs based on the number of initiator antennas. The responder then transmits a sounding packet to the initiator, wherein the sounding packet includes multiple LTFs corresponding to the number of LTFs specified in the TRQ. Based on the sounding packet, the initiator transmits a beamforming transmission to the responder to enable wireless data communication therebetween.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A sounding packet exchange method for wireless communication, comprising the steps of:
generating a training request (TRQ) specifying a number of long training fields (LTFs);
transmitting a TRQ from a transmit station having multiple antennas to a receive station over a wireless channel; and
wherein the TRQ specifies the number of LTFs based on the number of transmit station antennas.

2. The method of claim 1 further comprising the step of:
transmitting a sounding packet from the receive station to the transmit station, wherein the sounding packet includes multiple LTFs corresponding to said number of LTFs specified in the TRQ.

3. The method of claim 2 further comprising the steps of:
determining a beamforming vector based on the sounding packet; and
performing beamforming communication between the transmit station and the receive station using the beamforming vector.

4. The method of claim 2 wherein the step of performing beamforming communication further includes:
performing an analog beamforming transmission from the transmit station to the receive station based on the sounding packet; and
performing an analog beamforming transmission from the receive station to the transmit station based on the sounding packet.

5. The method of claim 4 wherein performing beamforming communication further comprises simultaneously performing analog beamforming communication at the transmit station and at the receive station based on the sounding packet.

6. The method of claim 2 wherein said beamforming comprises performing adaptive beamforming.

7. The method of claim 2 wherein said beamforming comprises performing switched beamforming.

8. The method of claim 1 wherein the TRQ includes a field specifying said number of LTFs.

9. The method of claim 2 wherein:
the receive station includes one antenna;
the step of transmitting the TRQ further comprises transmitting the TRQ by omni-directional transmission; and
the step of transmitting the sounding packet further comprises transmitting the sounding packet via omni-directional transmission.

10. A method of claim 2 wherein:
the step of transmitting a TRQ further includes transmitting a forward TRQ from the transmit station to the receive station, wherein the transmit station includes N antennas and the receive station includes M antennas, the forward TRQ specifying a number of LTFs required in a forward sounding packet; and
the step transmitting a sounding packet further includes, in response to the forward TRQ transmitting a forward sounding packet from the receive station to the transmit station, wherein the forward sounding packet includes multiple LTFs corresponding to said number of LTFs specified in the forward TRQ.

11. The method of claim 10 further comprising the step of using the forward sounding packet in the transmit station to determine a transmit beamforming vector.

12. The method of claim 11 further comprising the steps of:
transmitting a reverse TRQ from the receive station to the transmit station, the reverse TRQ specifying the number of LTFs required in a reverse sounding packet; and
in response to the reverse TRQ, transmitting a reverse sounding packet from the transmit station to the receive station, wherein the reverse sounding packet includes multiple LTFs corresponding to said number of LTFs specified in the reverse TRQ.

13. The method of claim 12 further comprising the step of using the reverse sounding packet to estimate the channel at the receive station.

14. The method of claim 13 further comprising the step of using the reverse sounding packet to calculate the statistical channel information at the receive station.

15. The method of claim 14 further comprising the step of using the reverse sounding packet to form an adaptive receive beamforming vector at the receive station for beamforming communication with the transmit station.

16. The method of claim 12 further comprising the step of based on the forward and the reverse sounding packets, simultaneously performing analog beamforming at the transmit station and at the receive station, respectively.

17. The method of claim 10 wherein:
the forward TRQ specifies a number of LTFs required in a forward sounding packet, based on the number of transmit station antennas; and
the reverse TRQ specifies a number of LTFs required in a reverse sounding packet, based on the number of receive station antennas.

18. A wireless communication system implementing sounding packet exchange, comprising:
an initiator having one or more antennas;
a responder having one or more antennas;
wherein the initiator includes a training module that is configured to generate a transmission request (TRQ) specifying a number of long training fields (LTFs) based on the number of initiator antennas, and a communication module that is configured to transmit the TRQ to the responder over a wireless channel.

19. The system of claim 18 wherein the responder includes:
a training module that is configured to generate a sounding packet including LTFs corresponding to said number of LTFs specified in the TRQ; and
a communication module that is configured to transmit the sounding packet to the initiator.

20. The system of claim 19 wherein the communication module of the initiator is further configured to determine a beamforming vector based on the sounding packet, and perform beamforming communication with the responder using the beamforming vector.

21. The system of claim 19 wherein:
the communication module of the initiator is further configured to perform analog beamforming transmission to the responder based on the sounding packet; and
the communication module of the responder is further configured to perform analog beamforming transmission to the initiator based on the sounding packet.

22. The system of claim 21 wherein the communications modules of the initiator and the responder are further configured to simultaneously perform analog beamforming communication based on the sounding packet.

23. The system of claim 19 wherein said beamforming comprises adaptive beamforming.

24. The system of claim 19 wherein said beamforming comprises switched beamforming.

25. The system of claim 18 wherein the TRQ includes a field specifying said number of LTFs.

26. The system of claim 19 wherein:
the responder includes one antenna;
the communication module of the initiator is further configured to transmit the TRQ by omni-directional transmission; and
the communication module of the responder is further configured to transmit the sounding packet via omni-directional transmission.

27. A system of claim 19 wherein:
the communication module of the initiator is further configured to transmit a forward TRQ to the responder, wherein the initiator includes N antennas and the responder includes M antennas, the forward TRQ specifying a number of LTFs required in a forward sounding packet; and
the communication module of the responder is further configured to transmit a forward sounding packet in response to the forward TRQ, wherein the forward sounding packet includes multiple LTFs corresponding to said number of LTFs specified in the forward TRQ.

28. The system of claim 27 wherein the communication module of the initiator is further configured to use the forward sounding packet to determine a transmit beamforming vector.

29. The system of claim 28 wherein:
the training module of the responder is further configured to transmit a reverse TRQ to the initiator, the reverse TRQ specifying the number of LTFs required in a reverse sounding packet; and
the training module of the initiator is further configured to generate a reverse sounding packet in response to the reverse TRQ for transmission to the responder by the communication module, wherein the reverse sounding packet includes multiple LTFs corresponding to said number of LTFs specified in the reverse TRQ.

30. The system of claim 29 wherein the communication module of the responder is further configured to use the reverse sounding packet to estimate the channel at the responder.

31. The system of claim 30 wherein the communication module of the responder is further configured to use the reverse sounding packet to calculate the statistical channel information at the responder.

32. The system of claim 31 wherein the communication module of the responder is further configured to use the reverse sounding packet to form an adaptive receive beamforming vector at the responder for beamforming communication with the initiator.

33. The system of claim 29 wherein the initiator and the responder are further configured such that based on the forward and the reverse sounding packets, the initiator and the responder simultaneously perform analog beamforming at the initiator and at the responder, respectively.

34. The system of claim 27 wherein:
the forward TRQ specifies a number of LTFs required in a forward sounding packet, based on the number of initiator antennas; and
the reverse TRQ specifies a number of LTFs required in a reverse sounding packet, based on the number of responder antennas.

35. A wireless communication station implementing sounding packet exchange, comprising:
an initiator having one or more antennas;
wherein the initiator includes a training module that is configured to generate a transmission request (TRQ) specifying a number of long training fields (LTFs) based on the number of initiator antennas, and a communication module that is configured to transmit the TRQ to a responder over a wireless channel.

36. The station of claim 35 wherein the communication module of the initiator is further configured to determine a beamforming vector based on a sounding packet from the responder, wherein the sounding packet includes LTFs corresponding to said number of LTFs specified in the TRQ, perform beamforming communication with the responder using the beamforming vector.

37. The station of claim 36 wherein:
the communication module of the initiator is further configured to perform analog beamforming transmission to the responder based on the sounding packet.

38. The station of claim 36 wherein said beamforming comprises adaptive beamforming.

39. The station of claim 36 wherein said beamforming comprises switched beamforming.

40. The station of claim 35 wherein the TRQ includes a field specifying said number of LTFs.

41. The station of claim 36 wherein:
the communication module of the initiator is further configured to transmit the TRQ by omni-directional transmission.

42. A wireless communication station implementing sounding packet exchange, comprising:
a responder having one or more antennas;
wherein the responder includes a training module that is configured to receive a TRQ from a initiator, the TRQ specifying a number of long training fields (LTFs) based on the number of initiator antennas, and to generate a sounding packet including LTFs corresponding to said number of LTFs specified in the TRQ; and
a communication module that is configured to transmit the sounding packet to the initiator.

43. The station of claim 42 wherein the communication module of the responder is further configured to perform analog beamforming transmission to the initiator.

44. The station of claim 43 wherein said beamforming comprises adaptive beamforming.

45. The station of claim 43 wherein said beamforming comprises switched beamforming.

46. The station of claim 42 wherein the TRQ includes a field specifying said number of LTFs.

47. The station of claim 42 wherein:
the communication module of the responder is further configured to transmit the sounding packet via omni-directional transmission.

48. The station of claim 42 wherein:
the initiator includes N antennas and the responder includes M antennas;
the communication module of the initiator is further configured to transmit a forward sounding packet in response to a forward TRQ from the initiator, the forward TRQ specifying a number of LTFs required in the forward sounding packet; and
the forward sounding packet including multiple LTFs corresponding to said number of LTFs specified in the forward TRQ.

49. The station of claim 48 wherein:
the training module of the responder is further configured to transmit a reverse TRQ to the initiator, the reverse TRQ specifying the number of LTFs required in a reverse sounding packet.

50. The station of claim 49 wherein the communication module of the responder is further configured to receive a reverse sounding packet from the initiator in response to the reverse TRQ, wherein the reverse sounding packet includes multiple LTFs corresponding to said number of LTFs specified in the reverse TRQ, and to use the reverse sounding packet to estimate the channel at the responder.

51. The station of claim 50 wherein the communication module of the responder is further configured to use the reverse sounding packet to calculate the statistical channel information at the responder.

52. The station of claim 51 wherein the communication module of the responder is further configured to use the reverse sounding packet to form an adaptive receive beamforming vector at the responder for beamforming communication with the initiator.

53. The station of claim 52 wherein:
the forward TRQ specifies a number of LTFs required in a forward sounding packet, based on the number of initiator antennas; and
the reverse TRQ specifies a number of LTFs required in a reverse sounding packet, based on the number of responder antennas.
